(19) United States
(12) Patent Application Publication
(10) Pub. No.: US 2026/0316827 A1
(43) Pub. Date: Oct. 15, 2026

(54) FOUR-WHEEL STEERING STRUCTURE

(71) Applicant: Nanjing Mijo Technology Co., Ltd., Nanjing (CN)

(72) Inventors: Dong ZHANG, Nanjing (CN); Xueguang FENG, Nanjing (CN); Fengpei YANG, Nanjing (CN)

(73) Assignee: Nanjing Mijo Technology Co., Ltd., Nanjing (CN)

(21) Appl. No.: 19/174,971

(22) Filed: Apr. 10, 2025

(51) Int. Cl. B62D 9/00; B62D 7/00

(52) U.S. Cl. CPC B62D 9/00; B62D 7/00

(57) ABSTRACT

A four-wheel steering structure includes a frame, two sets of steering parts, a front wheel part and a motor assembly, where one end of the frame is provided with the front wheel part, the other end of the frame is provided with the motor assembly, one set of the steering parts is arranged between the front wheel part and the frame, another set of the steering parts is arranged between the motor assembly and a vehicle, and two sets of the steering parts are mounted on the frame and rotate relative to the frame. The four-wheel steering structure solves the problems of large turning radius and low steering precision when the conventional front-wheel steering structure is operated in a narrow space. Moreover, the smaller turning radius and higher steering precision are realized, and the operation convenience and equipment adaptability are improved in a complex environment.

### TECHNICAL FIELD

The present invention relates to the technical field of medical devices, particularly to a four-wheel steering structure.

### BACKGROUND

In the application field of medical devices, steering structure is one of the key factors affecting equipment handling performance and applicable scenarios.

Most conventional steering systems adopt front wheel steering design. In some scenarios that require operation in a narrow space, such as indoor medical equipment movement, small storage vehicle handling, etc., vehicles with front wheel steering often require a larger turning radius. This not only increases the difficulty of operation and prolongs the operation time, but also may cause the equipment to fail to steer smoothly due to space constraints, and even cause potential safety hazards such as collisions. Moreover, in medical operation link that requires high steering accuracy, it is difficult for front wheel steering to achieve precise path control and cannot satisfy the requirements of use in complex environments.

Additionally, with the continuous development of science and technology, the requirements for the multifunction and adaptability of equipment are getting higher and higher, and the limitations of conventional front wheel steering structures are becoming more and more obvious, making it difficult to adapt to the diverse requirements of new application scenarios.

### SUMMARY

In order to overcome the deficiency of the prior art, an objective of the present invention is to provide a four-wheel steering structure, which solves the problems of large turning radius, low steering precision, inconvenient operation and potential safety hazards when the conventional front-wheel steering structure is operated in a narrow space, and through the unique four-wheel steering design, the smaller turning radius and higher steering precision are realized, and the operation convenience and equipment adaptability are improved in a complex environment.

In order to achieve the above objective, the present invention provides the following scheme:
a four-wheel steering structure includes a frame, two sets of steering parts, a front wheel part and a motor assembly, where one end of the frame is provided with the front wheel part, the other end of the frame is provided with the motor assembly, one set of the steering parts is arranged between the front wheel part and the frame, another set of the steering parts is arranged between the motor assembly and a vehicle, and two sets of the steering parts are mounted on the frame and rotate relative to the frame.

Preferably, the two sets of the steering parts are connected to the frame via a pin shaft and used for the steering parts to rotate around the pin shaft to transmit a steering force to the front wheel parts.

Preferably, the two sets of the steering parts include a front steering arm and a rear steering arm, the front steering arm is mounted on the frame and rotates relative to the frame, the rear steering arm is mounted on the frame and one end of the rear steering arm is provided with a sliding groove, and one end of the front steering arm is arranged in the sliding groove.

Preferably, the front wheel part includes a left front wheel and a right front wheel, the left front wheel and the right front wheel are mounted on both sides of the frame via bolts, and the left front wheel is connected to the corresponding part of the front steering arm via the pin shaft through a left front pull rod and used for driving the left front wheel to rotate around a mounting point of the left front wheel and the frame; the right front wheel is connected to the corresponding part of the front steering arm via the pin shaft through a right front pull rod and used for driving the right front wheel to rotate around the mounting point of the right front wheel and the frame.

Preferably, one end of the front steering arm and one end of the rear steering arm are connected via the pin shaft, and the other end of the rear steering arm is provided with a transmission mechanism, and the transmission mechanism and the other end of the rear steering arm are connected via the pin shaft, so as to realize that the rear steering arm drives the transmission mechanism to rotate.

Preferably, the motor assembly is mounted on one end of frame away from the front wheel part via bolts, and the motor assembly is connected to the rear steering arm via the transmission mechanism to form an integral rear wheel steering system; a connecting part of the transmission mechanism and the motor assembly adopts a rigid connection mode and used for driving the motor assembly to rotate around the mounting point of the motor assembly and the frame, and during a rotation process of the motor assembly, the transmission mechanism is used for stably transmitting a pulling force without loosening or displacement.

According to the specific embodiments provided by the present invention, the present invention discloses the following technical effects:
the four-wheel steering structure provided by the present invention effectively solves the problems of large turning radius, low steering precision, inconvenient operation and potential safety hazards when the conventional front-wheel steering structure is operated in a narrow space, and the front steering arm, the rear steering arm, the left front wheel, the right front wheel, the motor assembly and other parts are combined, and the connection and transmission mode thereof are accurately designed, so that when the front steering arm is rotated in the operation process, the left front wheel and right front wheel and the motor assembly can be rotated simultaneously and the four-wheel steering function is realized; compared with the conventional front wheel steering structure, the present invention significantly reduces the turning radius and greatly improves the operation convenience and steering flexibility in the indoors and other narrow spaces; meanwhile, this four-wheel collaborative steering method can achieve more accurate path control, which satisfies the requirements of application scenarios that require high steering accuracy, and effectively improve the adaptability and handling performance of the equipment in complex environments.

### BRIEF DESCRIPTION OF THE DRAWINGS

To explain the embodiments of the present invention or the technical solutions in the prior art more clearly, a brief introduction will be made to the accompanying drawings used in the embodiments or the description of the prior art. It is obvious that the drawings in the description below are only some embodiments of the present invention, and those ordinarily skilled in the art can obtain other drawings according to these drawings without creative work.

FIG. 1 is an overall schematic diagram of a four-wheel steering structure according to the present invention;

FIG. 2 is a schematic diagram of a mounting point of a structure according to embodiment 1 of the present invention;

FIG. 3 is a rotating schematic diagram of a mounting point of a structure according to embodiment 1 of the present invention;

FIG. 4 is a rotating schematic diagram of a mounting point of a structure in another situation according to embodiment 1 of the present invention.

### REFERENCE NUMERALS IN FIGURES

1, a left front wheel; 2, a left front pull rod; 3, a front steering arm; 4, a right front pull rod; 5, a right front wheel; 6, a rear steering arm; 7, a frame; 8, a transmission mechanism; 9, a motor assembly.

### DETAILED DESCRIPTION OF THE EMBODIMENTS

The following clearly and completely describes the technical solutions in embodiments of the present invention with reference to the drawings of the embodiments of the present invention. Apparently, the described embodiments are only some but not all of the embodiments of the present invention. All other embodiments obtained by those of ordinary skill in the art based on the embodiments of the present invention without involving any creative effort shall fall within the scope of protection of the present invention.

In order that the objectives, features and advantages of the present invention described above may be more readily understood, the present invention is described in further detail below in conjunction with the accompanying drawings and specific embodiments.

### Embodiment 1

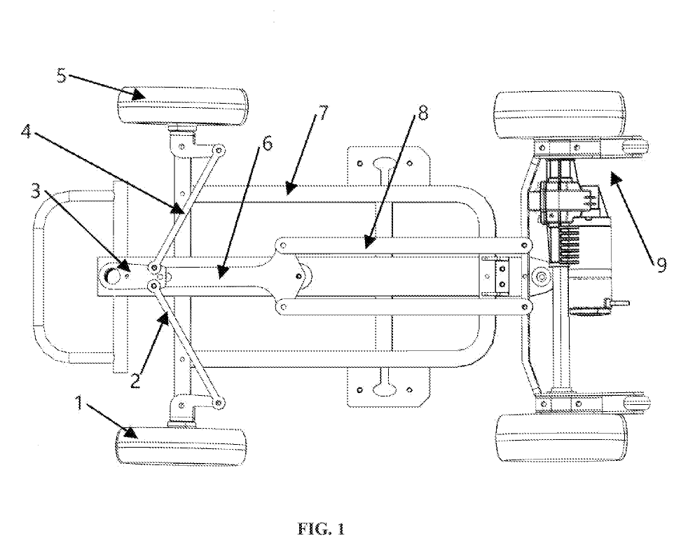

As shown in FIG. 1, the four-wheel steering structure is provided in the present invention, the structure includes the frame 7, two sets of steering parts, the front wheel part and the motor assembly 9, where one end of the frame 7 is provided with the front wheel part, the other end of the frame 7 is provided with the motor assembly 9, one set of the steering parts is arranged between the front wheel part and the frame 7, another set of the steering parts is arranged between the motor assembly 9 and the vehicle, and two sets of the steering parts are mounted on the frame 7 and rotate relative to the frame 7.

The two sets of the steering parts are connected to the frame 7 via the pin shaft and used for the steering parts to rotate around the pin shaft to transmit the steering force to the front wheel parts. The two sets of the steering parts include the front steering arm 3 and the rear steering arm 6, the front steering arm 3 is mounted on the frame 7 and rotates relative to the frame 7, the rear steering arm 6 is mounted on the frame 7 and is provided with the sliding groove, and one end of the front steering arm 3 is arranged in the sliding groove.

In the aforementioned, the front wheel part includes the left front wheel 1 and the right front wheel 5, the left front wheel 1 and the right front wheel 5 are mounted on both sides of the frame 7 via bolts, the left front wheel 1 is connected to the corresponding part of the front steering arm 3 via the pin shaft through a left front pull rod 2 and used for driving the left front wheel 1 to rotate around the mounting point of the left front wheel 1 and the frame 7; the right front wheel 5 is connected to the corresponding part of the front steering arm 3 via the pin shaft through the right front pull rod 4 and used for driving the right front wheel 5 to rotate around the mounting point of the right front wheel 5 and the frame 7. One end of the front steering arm 3 and one end of the rear steering arm 6 are connected via the pin shaft, and the other end of the rear steering arm 6 is connected to the transmission mechanism 8 and used for realizing that the rear steering arm 6 drives the transmission mechanism 8 to rotate. The motor assembly 9 is mounted on one end of frame 7 away from the front wheel part via bolts, and the motor assembly 9 is connected to the rear steering arm 6 via the transmission mechanism 8 to form an integral rear wheel steering system; the connecting part of the transmission mechanism 8 and the motor assembly 9 adopts the rigid connection mode and used for driving the motor assembly 9 to rotate around the mounting point of the motor assembly 9 and the frame 7, and during the rotation process of the motor assembly 9, the transmission mechanism 8 is used for stably transmitting the pulling force without loosening or displacement. The transmission mechanism 8 includes, but is not limited to, a pull rod type structure, a gear type structure and a synchronous belt type structure, and in the embodiment, the pull rod type structure is preferred, and the pull rod type structure is composed of two sets of rear pull rods arranged in parallel and symmetrically.

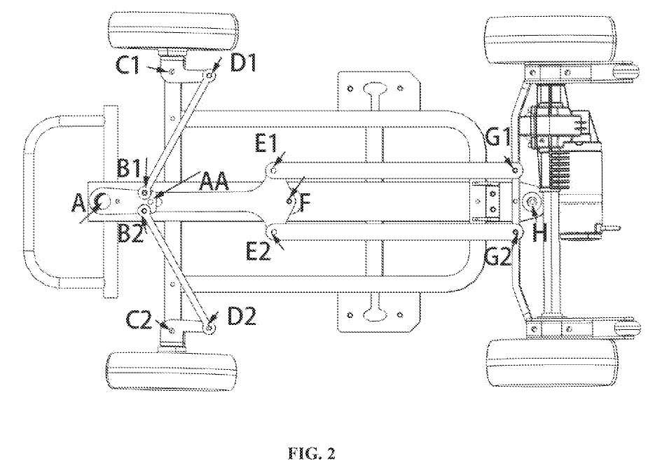

As shown in FIG. 2, the front steering arm 3 is mounted on the frame 7 via the point A, the left front wheel 1 is mounted on one side of the frame 7 via the point C2, the right front wheel 5 is mounted on the other side of the frame 7 via the point C1, the left front pull rods 2 are respectively mounted at the left front wheel 1 and on the front steering arm 3 via the point D2 and point B2, the right front pull rods 4 are respectively mounted at the right front wheel 5 and on the front steering arm 3 via the point D1 and point B1, the front steering arm 3 is connected to the rear steering arm 6 via the point AA, and the rear steering arm 6 is mounted on the frame 7 via the point F, the rear steering arms 6 are respectively connected to the corresponding rear pull rods via the point E1 and point E2, the two sets of rear pull rods are respectively connected to the motor assembly 9 via the point G1 and point G2, and the click assembly is connected to the frame 7 via the point H. The front steering arm 3 is rotated to rotate around the point A, the left front pull rod 2 and the right front pull rod 4 are pulled to rotate the left front wheel 1 and the right front wheel 5 around the corresponding point C2 and point C1, so as to achieve the front wheel steering function, meanwhile, the front steering arm 3 moves linearly in the sliding groove of the rear steering arm 6, since the contact point between the front steering arm 3 and the rear steering arm 6 changes in rotation, the rear steering arm 6 rotates around the point F, and the rear part of the rear steering arm 6 is connected to the motor assembly 9 via two sets of rear pull rods, and when the rear steering arm 6 rotates around the point F, the motor is pulled to rotate around the point H, so as to achieve the rear wheel steering function.

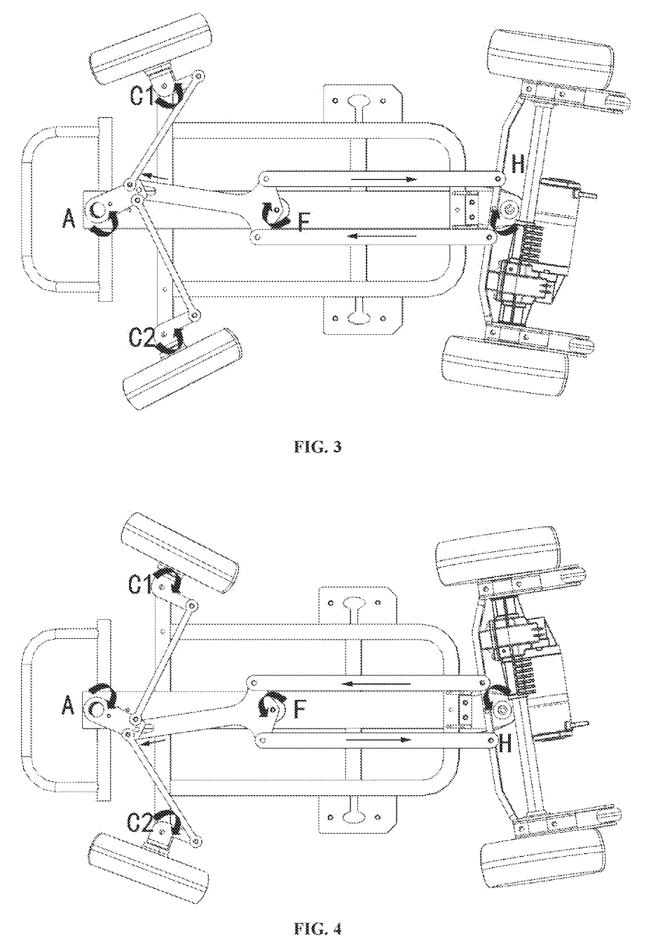

Principle of operation: with reference to FIG. 3, when the four-wheel steering structure is operating, the front steering arm 3 rotates counterclockwise around the point A, at this time, point C2 of the left front pull rod 2 and point C1 of the right front pull rod 4 are rotated counterclockwise simultaneously, thereby driving the left front wheel 1 and the right front wheel 5 to steer, and meanwhile, the rear steering arm 6 is affected by the rotation of the front steering arm 3, the rear steering arm 6 rotates clockwise around the point F, and the motor assembly 9 is driven to steer via the two sets of rear pull rods, and the motor assembly 9 rotates clockwise around the point H. With additional reference to FIG. 4, the current steering arm 3 rotates clockwise around point A, at this time, point C2 of the left front pull rod 2 and point C1 of the right front pull rod 4 are rotated clockwise simultaneously, thereby driving the left front wheel 1 and the right front wheel 5 to steer, and meanwhile, the rear steering arm 6 is affected by the rotation of the front steering arm 3, and the rear steering arm 6 rotates counterclockwise around the point F, and the motor assembly 9 is driven to steer via the two sets of rear pull rods, and the motor assembly 9 rotates counterclockwise around the point H, thereby realizing the steering of the four-wheel structure.

Therefore, the above-mentioned four-wheel steering structure is adopted to solve the problems of large turning radius, low steering precision, inconvenient operation and potential safety hazards when the conventional front-wheel steering structure is operated in a narrow space, and through the unique four-wheel steering design, the smaller turning radius and higher steering precision are realized, and the operation convenience and equipment adaptability are improved in a complex environment.

In this paper, specific embodiments of the principles of the present invention and the mode of implementation have been applied to elaborate, the above embodiments are only used to help understand the method of the present invention and its core ideas; meanwhile, for the general technical personnel in the field, there will be a change in the specific mode of implementation and the scope of application based on the ideas of the present invention. In summary, the contents of this specification should not be construed as a limitation of the present invention.

What is claimed is:

1. A four-wheel steering structure, wherein comprising a frame, two sets of steering parts, a front wheel part and a motor assembly, wherein a first end of the frame is provided with the front wheel part, a second end of the frame is provided with the motor assembly, a first set of the steering parts of the two sets of the steering parts is arranged between the front wheel part and the frame, a second set of the steering parts of the two sets of the steering parts is arranged between the motor assembly and a vehicle, and the two sets of the steering parts are mounted on the frame and rotate relative to the frame.

2. The four-wheel steering structure according to claim 1, wherein the two sets of the steering parts are connected to the frame via a pin shaft and used to rotate around the pin shaft to transmit a steering force to the front wheel part.

3. The four-wheel steering structure according to claim 2, wherein the two sets of the steering parts comprise a front steering arm and a rear steering arm, wherein the front steering arm is mounted on the frame and rotates relative to the frame, the rear steering arm is mounted on the frame, a first end of the rear steering arm is provided with a sliding groove, and an end of the front steering arm is arranged in the sliding groove.

4. The four-wheel steering structure according to claim 3, wherein the front wheel part comprises a left front wheel and a right front wheel, wherein the left front wheel and the right front wheel are mounted on both sides of the frame via first bolts, the left front wheel is connected to a corresponding part of the front steering arm via the pin shaft through a left front pull rod and used for driving the left front wheel to rotate around a mounting point of the left front wheel and the frame; the right front wheel is connected to a corresponding part of the front steering arm via the pin shaft through a right front pull rod and used for driving the right front wheel to rotate around a mounting point of the right front wheel and the frame.

5. The four-wheel steering structure according to claim 4, wherein the end of the front steering arm and the first end of the rear steering arm are connected via the pin shaft, a second end of the rear steering arm is provided with a transmission mechanism, and the transmission mechanism and the second end of the rear steering arm are connected via the pin shaft, so as to realize that the rear steering arm drives the transmission mechanism to rotate.

6. The four-wheel steering structure according to claim 5, wherein the motor assembly is mounted on an end of the frame away from the front wheel part via second bolts, and the motor assembly is connected to the rear steering arm via the transmission mechanism to form an integral rear wheel steering system; a connecting part of the transmission mechanism and the motor assembly adopts a rigid connection mode and used for driving the motor assembly to rotate around a mounting point of the motor assembly and the frame, and during a rotation process of the motor assembly, the transmission mechanism is used for stably transmitting a pulling force without loosening or displacement.
